(19) United States
(12) Patent Application Publication
(10) Pub. No.: US 2016/0236486 A1
(43) Pub. Date: Aug. 18, 2016

(54) INKJET PRINTER

(71) Applicant: MIMAKI ENGINEERING CO., LTD., Tomi-shi, Nagano (JP)

(72) Inventor: Akira IKEDA, Nagano (JP)

(73) Assignee: MIMAKI ENGINEERING Co., Ltd., Tomi-shi, Nagano (JP)

(21) Appl. No.: 15/026,600

(22) PCT Filed: Sep. 29, 2014
(86) PCT No.: PCT/JP2014/075778

§ 371 Date: Apr. 1, 2016

(30) Foreign Application Priority Data
Oct. 4, 2013 (JP) 2013-209556

(51) Int. Cl. B41J 11/00

(52) U.S. Cl. CPC B41J 11/002

(57) ABSTRACT

An inkjet printer is provided. The inkjet printer can improve the efficiency of heating of a platen by a heater as compared to that in the related art. The inkjet printer includes: a print platen that has a supporting surface for supporting a recording medium onto which a recording head ejects ink, and a plurality of through-holes formed in the supporting surface; a print heater that heats the print platen; a fan that produces a flow of gas by making gas existing on a side of the supporting surface with respect to the through-holes move through the through-holes; and a sheet that is able to cover at least a part of the supporting surface, thereby shielding at least a part of the plurality of through-holes, and is able to change an area to cover the supporting surface.

### TECHNICAL FIELD

The disclosure relates to an inkjet printer which includes a platen configured to have a supporting surface for supporting a recording medium and a plurality of through-holes formed in the supporting surface, and a fan configured to produce a flow of gas, existing on the supporting surface side with respect to the through-holes, through the through-holes.

### BACKGROUND ART

As an inkjet printer according to the related art, there is known an inkjet recording apparatus which includes an accommodating tray configured to accommodate recording sheets which are recording media, a side guide configured to regulate the rear ends of recording sheets in the accommodating tray, a recording head configured to eject ink, a platen configured to support each recording sheet onto which the recording head ejects ink, an intake fan that is a fan configured to produce a flow of gas, a slide shutter configured to be able to cover at least a part of the platen, a side pressing tool configured to be attached to the leading end portion of the slide shutter and suppress an end portion of each recording sheet from rising up from the platen, and a coupling arm configured to couple the side guide with the slide shutter, thereby transmitting linear motion of the side guide directly to the slide shutter (refer to Patent Document 1).

The platen of the inkjet recording apparatus disclosed in Patent Document 1 has a top surface which is a supporting surface for supporting each recording sheet, and a plurality of suction holes which are through-holes foimed in the top surface.

The intake fan of the inkjet recording apparatus disclosed in Patent Document 1 is configured to produce a flow of gas, existing on the top surface side of the platen with respect to the suction holes of the platen, through the suction holes.

The slide shutter of the inkjet recording apparatus disclosed in Patent Document 1 is configured to be able to cover at least a part of the top surface of the platen, thereby shielding at least some of the plurality of suction holes of the platen, and be able to change an area to cover the top surface of the platen. This slide shutter is configured to operate simultaneously with the side guide coupled with the slide shutter by the coupling aim, thereby being fixed at a position according to the width dimension of a recording sheet with respect to the platen. Also, in a case where the slide shutter is formed by a member which is deformable and flexible and has a flat plate shape, the slide shutter is configured to be able to be accommodated in a state where a range protruding from an end portion of the platen is bent, for example, downward.

### PRIOR ART DOCUMENT

### Patent Document

Patent Document 1: JP-A-2000-153604

### SUMMARY

### Problem to be Solved

The inkjet recording apparatus disclosed in Patent Document 1 does not include a heater configured to heat the platen. However, in the related art, there are known inkjet printers including heaters configured to heat platens.

In an inkjet printer including a platen configured to include a supporting surface for supporting each recording medium and a plurality of through-holes formed in the supporting surface, a fan configured to produce a flow of gas, existing on the supporting surface side with respect to the through-holes, through the through-holes, and a heater configured to heat the platen, since the platen heated by the heater is cooled by the flow of gas produced by the fan, the efficiency of heating of the platen by the heater is low. The inventor of this application focused attention on that point.

Therefore, the disclosure provides an inkjet printer capable of improving the efficiency of heating of a platen by a heater as compared to that in the related art.

### Solutions to the Problem

An inkjet printer of the disclosure includes: a recording head that is configured to eject ink; a platen that is configured to support a recording medium onto which the recording head ejects ink; a heater that is configured to heat the platen; a fan that is configured to produce a flow of gas; and sheets that are configured to be able to cover at least a part of the platen, wherein the platen has a supporting surface for supporting the recording medium, and a plurality of through-holes formed in the supporting surface, wherein the fan produces the flow of gas, existing on the supporting surface side with respect to the through-holes, through the through-holes, and wherein the sheets can cover at least a part of the supporting surface, thereby capable of shielding at least some of the plurality of through-holes, and can change an area to cover the supporting surface.

According to this configuration, in the inkjet printer of the disclosure, since a part of the supporting surface of the platen which does not support a recording medium is covered by the sheets (hereinafter, referred to as a “medium non-support part”), whereby it is possible to shield the through-holes of the medium non-support part, it is possible to suppress gas from being forced to flow through the through-holes of the medium non-support part by the fan. Therefore, the inkjet printer of the disclosure can suppress cooling of the platen due to the flow of gas through the through-holes of the medium non-support part produced by the fan, and thus can improve the efficiency of heating of the platen by the heater as compared to that in the related art.

Also, in the inkjet printer of the disclosure, the heater may be disposed at a position on the opposite side of the through-holes to the supporting surface side, in a space where gas getting out of the through-holes passes.

According to this configuration, in the inkjet printer of the disclosure, since the heater is disposed in the space where gas entering through-holes from the supporting surface side of the platen and getting out of the through-holes passes, gas entering through-holes from the supporting surface side of the platen and getting out of the through-holes passes the vicinity of the heater, and thus the heater can be easily cooled by the gas. Therefore, the inkjet printer of the disclosure further improves the efficiency of heating of the platen by the heater as compared to a configuration in which the heater is not disposed in the space where gas getting out of through-holes passes.

Also, the inkjet printer of the disclosure may include winding members that are configured to be able to wind the sheets, and fixed members that are configured to be attached to the sheets attached to the winding members and be fixable at a plurality of positions with respect to the platen.

According to this configuration, in the inkjet printer of the disclosure, in a case where the sheets move with respect to the platen, the sheets are wound. Therefore, as compared to a configuration in which the sheets move with respect to the platen without being wound, it is possible to reduce a space for accommodating the sheets, and thus it is possible to reduce the size of the whole of the inkjet printer.

Also, the inkjet printer of the disclosure may include biasing members that are configured to bias the winding members in the winding directions of the sheets.

According to this configuration, in the inkjet printer of the disclosure, as long as the positions of the fixed members relative to the platen change, the sheets can be automatically wound around the winding members by the biasing forces of the biasing members. Therefore, as compared to a configuration in which a user manually winds the sheets around the winding members, it is possible to suppress the burden of a user.

Also, in the inkjet printer of the disclosure, the fixed members may be guide members that are configured to guide conveyance of the recording medium.

According to this configuration, in the inkjet printer of the disclosure, the fixed members have both of a function of fixing the sheets with respect to the platen and a function of guiding conveyance of a recording medium. Therefore, as long as the fixed members are fixed with respect to the platen according to the width of a recording medium in order to make the fixed members guide conveyance of the recording medium, it is possible to improve the platen heating efficiency of the heater by the sheets.

### Technical Effects

The inkjet printer of the disclosure can improve the efficiency of heating of the platen by the heater as compared to that in the related art.

### BRIEF DESCRIPTION OF THE DRAWINGS

FIG. 1 is a perspective view of an inkjet printer according to an illustrative embodiment of the disclosure in a state where the inkjet printer is conveying a recording medium.

FIG. 2 is a sectional side view of the inkjet printer shown in FIG. 1.

FIG. 3 is a sectional front view of a part, surrounding a print platen, of the inkjet printer shown in FIG. 1.

FIG. 4 is a plan view of a part, surrounding the print platen, of the inkjet printer shown in FIG. 1.

FIG. 5 is a perspective view of a part, surrounding a guide member, of the inkjet printer shown in FIG. 1 in a state where the inkjet printer is conveying a recording medium.

FIG. 6 is a block diagram of the inkjet printer shown in FIG. 1.

FIG. 7 is a sectional front view of a part, surrounding the print platen, of the inkjet printer shown in FIG. 1 in a state where the inkjet printer is conveying a recording medium.

FIG. 8 is a plan view of a part, surrounding the print platen, of the inkjet printer shown in FIG. 1 in a state where the inkjet printer is conveying a recording medium.

### EMBODIMENTS OF THE DISCLOSURE

Hereinafter, an illustrative embodiment of the disclosure will be described with reference to drawings.

First, the configuration of an inkjet printer according to the illustrative embodiment will be described.

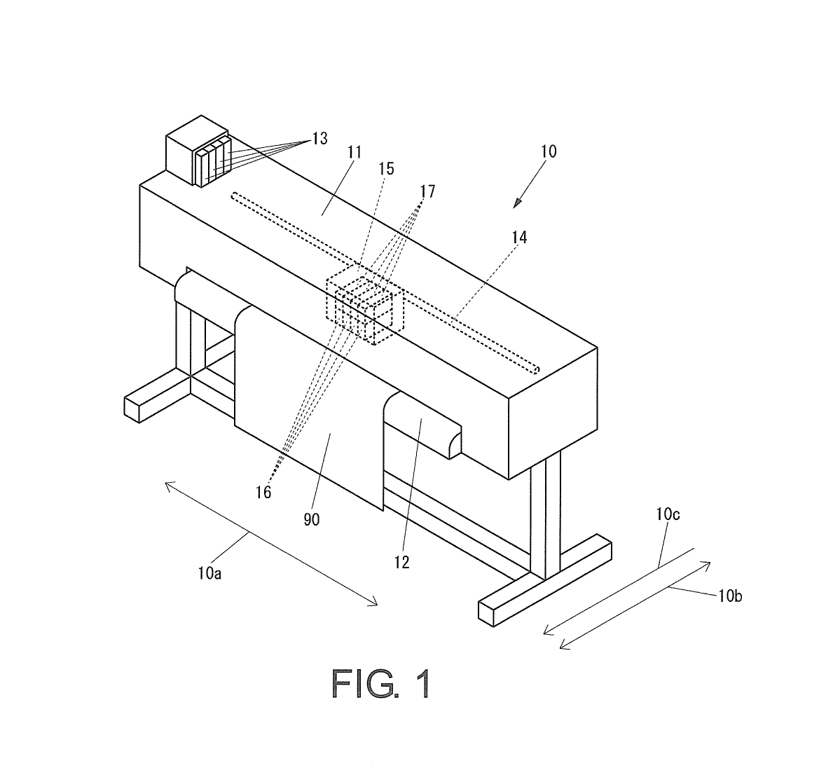

FIG. 1 is a perspective view of an inkjet printer 10 according to the illustrative embodiment in a state where the inkjet printer is conveying a recording medium 90 such as a sheet of paper.

As shown in FIG. 1, the inkjet printer 10 includes: a housing 11; a conveying device 12 configured to be disposed at a lower part of the housing 11 and convey a recording medium 90 in a sub scan direction shown by an arrow 10b and perpendicular to a main scan direction shown by an arrow 10a; a tank 13 configured to be disposed at an upper part of the housing 11 and contain ink; a guide rail 14 configured to extend in the main scan direction shown by the arrow 10a; a carriage 15 configured to be supported on the guide rail 14 so as to be movable in the main scan direction shown by the arrow 10a; a recording head 16 configured to be mounted on the carriage 15 and eject ink toward each recording medium 90; and a pressure damper 17 that is a device configured to be mounted on the carriage 15 and adjust the pressure of ink to be supplied from the tank 13 to the recording head 16 to a negative pressure of a predetermined range.

The housing 11 accommodates the guide rail 14, the carriage 15, the recording head 16, and the pressure damper 17.

The inkjet printer 10 is an apparatus configured to move the recording head 16 in the main scan direction, with respect to a recording medium 90 which does not move in the main scan direction shown by the arrow 10a, by the carriage 15, and eject ink from the nozzles of the recording head 16 toward the recording medium 90, thereby performing printing in the main scan direction with the recording head 16. Also, the inkjet printer 10 is an apparatus configured to convey the recording medium 90 in the sub scan direction, with respect to the recording head 16 which is not move in the sub scan direction shown by the arrow 10b, by the conveying device 12, thereby changing the position of the recording head 16 relative to the recording medium 90 in the sub scan direction whenever printing in the main scan direction finishes.

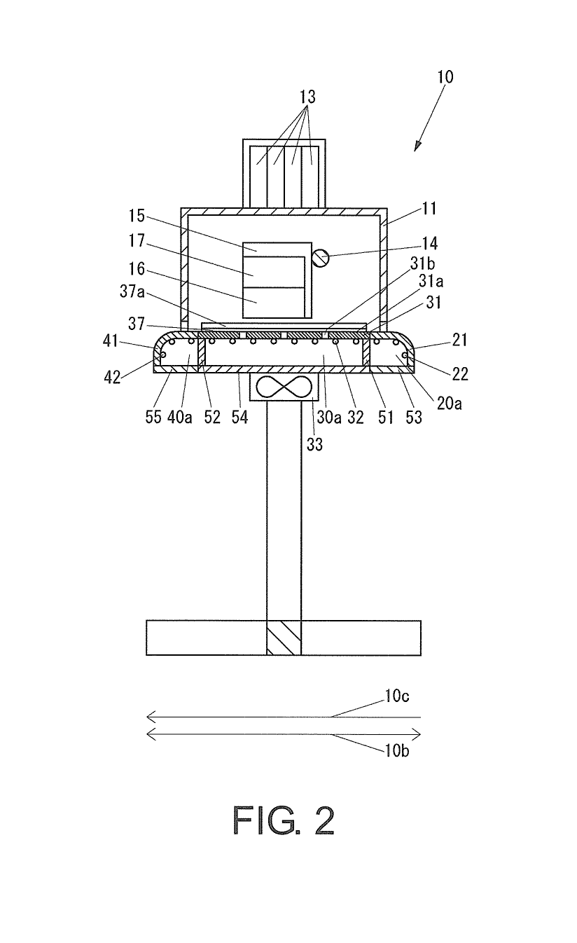

FIG. 2 is a sectional side view of the inkjet printer 10.

As shown in FIG. 2, the inkjet printer 10 includes: a pre-platen 21 configured to be disposed on the upstream side of the recording head 16 in the conveyance direction of a recording medium 90 (refer to FIG. 1) shown by an arrow 10c in the sub scan direction shown by the arrow 10b and to support the recording medium 90; a pre-heater 22 configured to heat the pre-platen 21 in order to preheat the recording medium 90 to be conveyed toward a position facing the recording head 16; a print platen 31 that is a platen of the disclosure configured to be disposed at a position facing the recording head 16 and support the recording medium 90; a print heater 32 that is a heater of the disclosure configured to be disposed at a position facing the recording head 16 and heat the print platen 31 in order to heat the recording medium 90; an after-platen 41 configured to be disposed on the downstream side from the recording head 16 in the conveyance direction shown by the arrow 10c and support the recording medium 90; and an after-heater 42 configured to heat the after-platen 41 in order to heat the recording medium 90 conveyed from the position facing the recording head 16.

The print platen 31 is configured to have a supporting surface 31a for supporting each recording medium 90 and a plurality of through-holes 31b formed in the supporting surface 31a.

The pre-heater 22 is a device configured to preheat a recording medium 90 to be conveyed toward the position facing the recording head 16, through the pre-platen 21, such that ink ejected by the recording head 16 dries up quickly from when the ink is attached to the recording medium 90.

The print heater 32 is a device configured to be disposed at a position facing the recording head 16 and heat a recording medium 90 through the print platen 31, such that ink ejected by the recording head 16 dries up quickly from when the ink is attached to the recording medium 90.

The after-heater 42 is a device configured to heat a recording medium 90, conveyed from the position facing the recording head 16, through the after-platen 41, such that ink ejected by the recording head 16 and attached to the recording medium 90 can surely dry up.

As described above, ink ejected by the recording head 16 and attached to a recording medium 90 dries up quickly and surely on the recording medium 90 by heat generated by the pre-heater 22, the print heater 32, and the after-heater 42, whereby bleeding is suppressed. Therefore, the inkjet printer 10 can form high-quality images on recording media 90 with ink.

The inkjet printer 10 includes a wall member 51 which separates a space 20a where the pre-heater 22 is disposed, and a space 30a where the print heater 32 is disposed. Also, the inkjet printer 10 includes a wall member 52 which separates the space 30a and a space 40a where the after-heater 42 is disposed. Further, the inkjet printer 10 includes a base member 53 that blocks the bottom of the space 20a, a base member 54 that blocks the bottom of the space 30a, and a base member 55 that blocks the bottom of the space 40a.

The inkjet printer 10 includes a fan 33 configured to be attached to the base member 54 and produce a flow of gas. The fan 33 is configured to suck gas in the space 30a and to discharge the gas out of the space 30a, thereby lowering the atmosphere pressure of the inside of the space 30a. If the atmosphere pressure of the inside of the space 30a falls, gas existing on a side of the supporting surface 31a with respect to the through-holes 3 lb of the print platen 31 moves into the space 30a through the through-holes 31b. In other words, the fan 33 is configured to produce a flow of gas, existing on the side of the supporting surface 31a with respect to the through-holes 31b of the print platen 31, into the space 30a through the through-holes 31b.

The print heater 32 is disposed inside the space 30a. In other words, the print heater 32 is disposed at a position on the opposite side of the side of the supporting surface 31a with respect to the through-holes 31b of the print platen 31, and the print heater 32 is disposed inside the space 30a where gas getting out of the through-holes 31b passes.

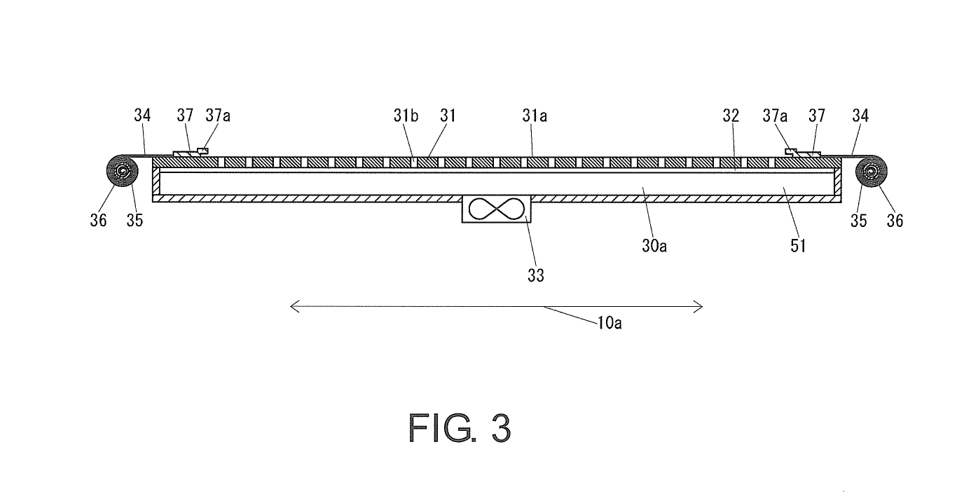

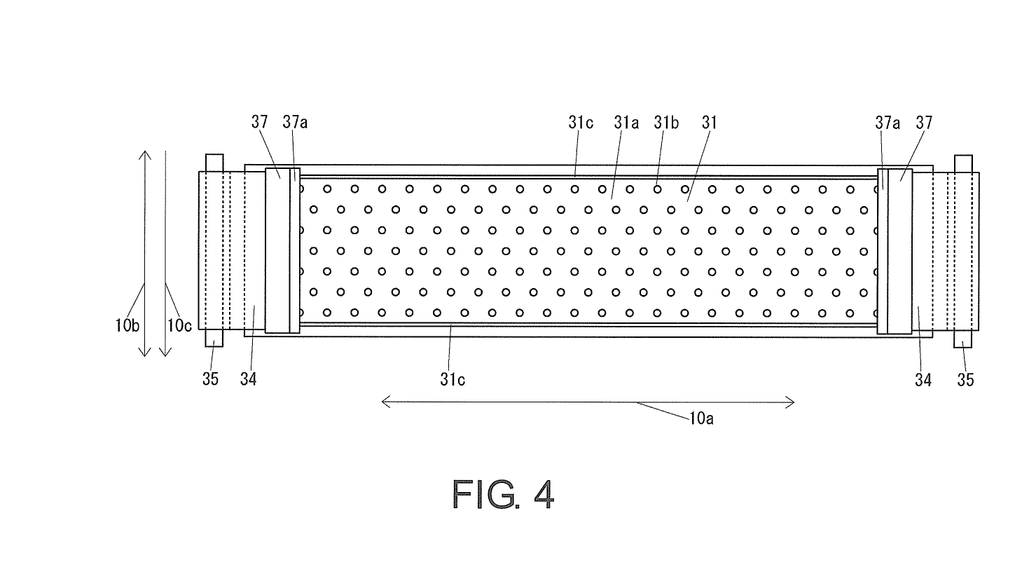

FIG. 3 is a sectional front view of a part, surrounding the print platen 31, of the inkjet printer 10. FIG. 4 is a plan view of a part, surrounding the print platen 31, of the inkjet printer 10.

As shown in FIGS. 3 and 4, the inkjet printer 10 (refer to FIG. 1) includes: sheets 34 configured to be able to cover at least a part of the print platen 31; rollers 35 that are winding members configured to be able to wind the sheets 34; spiral springs 36 that are biasing members configured to bias the rollers 35 in the winding directions of the sheets 34; and guide members 37 configured to guide conveyance of each recording medium 90.

The sheets 34 are attached to the rollers 35 and the guide members 37. The sheets 34 can cover at least a part of the supporting surface 31a of the print platen 31, thereby shielding at least a part of the plurality of through-holes 31b. The sheets 34 can change an area to cover the supporting surface 31a, according to change in the positions of the guide members 37 related to the print platen 31. Also, as a material for the sheet 34, for example, a resin, a metal, or the like can be used.

The rollers 35 extend in the sub scan direction shown by the arrow 10b, and are supported on the housing 11 (refer to FIG. 1) such that they are rotatable.

The spiral springs 36 are included inside the rollers 35. One end of each spiral spring 36 is fixed to the housing 11, and the other end thereof is fixed to a corresponding roller 35.

The print platen 31 is provided with two guide grooves 31c formed so as to extend in the main scan direction shown by the arrow 10a and be separate from each other in the sub scan direction shown by the arrow 10b. The guide members 37 have protrusions (not shown) fit in the guide grooves 31c of the print platen 31, and can be moved in the main scan direction shown by the arrow 10a as the protrusions are guided along the guide grooves 31c. The guide members 37 can be fixed at a plurality of positions with respect to the print platen 31 by frictional forces which are generated between the guide members and the print platen 31. In other words, the guide members 37 constitute fixed members of the disclosure.

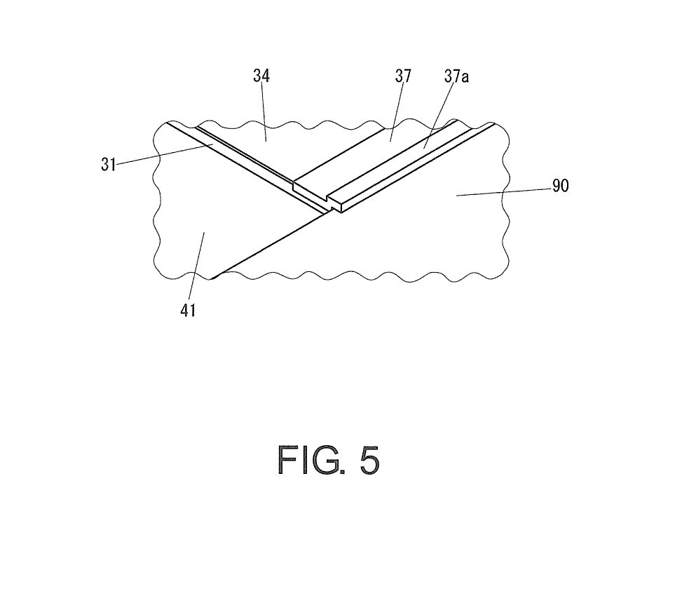

FIG. 5 is a perspective view of a part, surrounding a guide member 37, of the inkjet printer 10 in a state where the inkjet printer is conveying a recording medium 90.

As shown in FIG. 5, a guide member 37 includes a rising suppressing unit 37a configured to suppress rising up of an end of a recording medium 90 in the main scan direction shown by the arrow 10a.

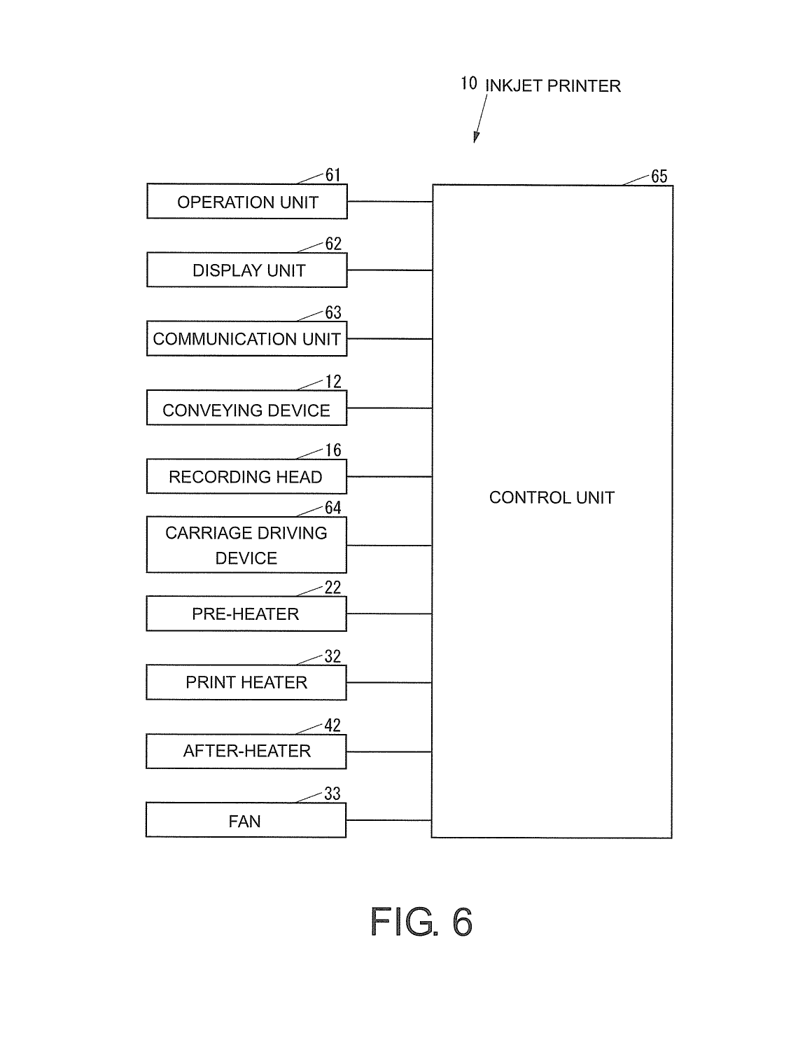

FIG. 6 is a block diagram of the inkjet printer 10.

As shown in FIG. 6, the inkjet printer 10 includes: an operation unit 61 that is an input device such as buttons to which various operations of a user are input; a display unit 62 that is a display device such as an LCD (liquid crystal display) configured to display a variety of information; a communication unit 63 which is a communication device configured to perform communication with external apparatuses such as a PC (personal computer); the conveying device 12 and the recording head 16 described above; a carriage driving device 64 configured to move the carriage 15 (refer to FIG. 1) in the main scan direction shown by the arrow 10a (refer to FIG. 1); the pre-heater 22, the print heater 32, the after-heater 42, and the fan 33 described above; and a control unit 65 configured to control the whole of the inkjet printer 10.

The control unit 65 includes, for example, a CPU (central processing unit), a ROM (read only memory) configured to retain programs and a variety of data, a RAM (random access memory) configured to be usable as a work area of the CPU. The CPU is configured to execute programs retained in the ROM.

Now, operations of the inkjet printer 10 will be described.

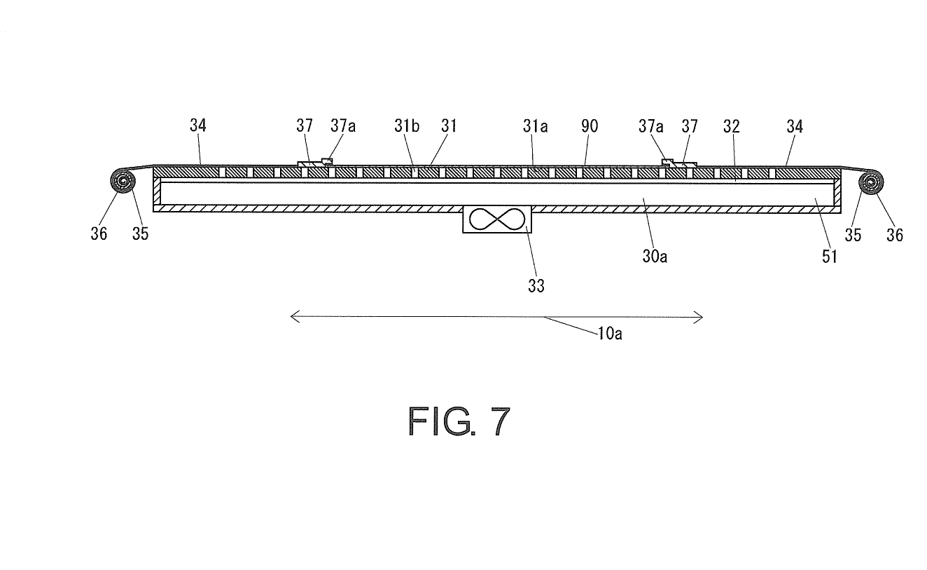

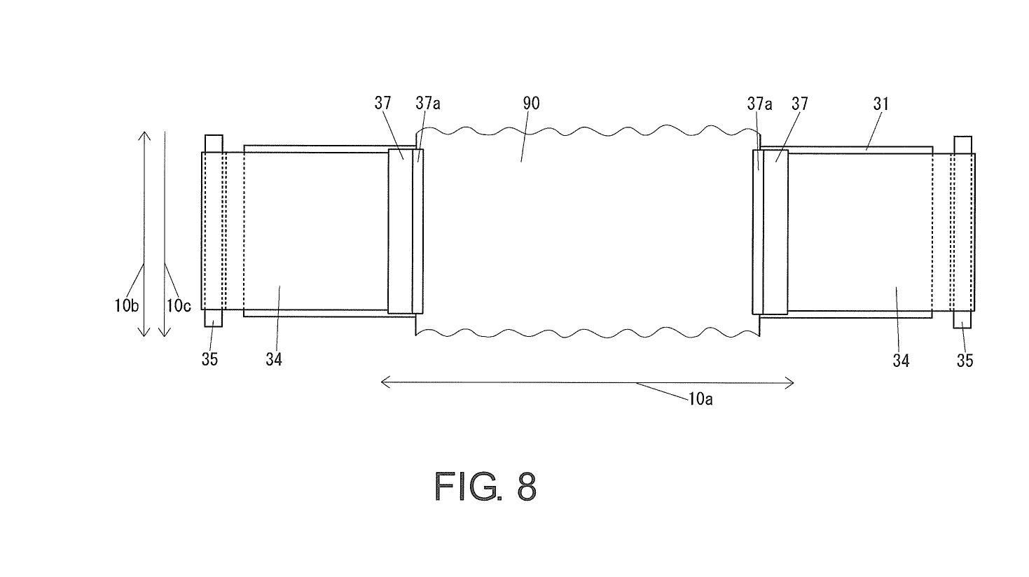

FIG. 7 is a sectional front view of a part, surrounding the print platen 31, of the inkjet printer 10 in a state where the inkjet printer is conveying a recording medium 90. FIG. 8 is a plan view of a part, surrounding the print platen 31, of the inkjet printer 10 in a state where the inkjet printer is conveying a recording medium 90.

As shown in FIGS. 7 and 8, a user can adjust the positions of the guide members 37 relative to the print platen 31, according to the width of a recording medium 90 in the main scan direction shown by the arrow 10a.

Further, the user can transmit print data from a computer such as a PC to the inkjet printer 10.

If receiving the printing data through the communication unit 63, the control unit 65 of the inkjet printer 10 drives the pre-heater 22, the print heater 32, the after-heater 42, and the fan 33 while performing control on the basis of the print data received through the communication unit 63 such that the conveying device 12 conveys a recording medium 90 with respect to the recording head 16 in the sub scan direction shown by the arrow 10b, and the carriage driving device 64 moves the carriage 15 in the main scan direction shown by the arrow 10a, thereby moving the recording head 16 with respect to the recording medium 90 in the main scan direction, and the recording head 16 ejects ink toward the recording medium 90, thereby printing an image based on the print data on the recording medium 90.

In this stage, ink ejected by the recording head 16 and attached to the recording medium 90 dries up quickly and surely on the recording medium 90 by heat generated by the pre-heater 22, the print heater 32, and the after-heater 42, as described above, whereby bleeding is suppressed. Therefore, the inkjet printer 10 can form high-quality images on recording media 90 with ink.

Also, a recording medium 90 which the conveying device 12 conveys in the conveyance direction shown by the arrow 10c is sucked onto the supporting surface 31a of the print platen 31 by suction force through the plurality of through-holes 31b of the print platen 31 caused by a flow of gas produced by the fan 33, whereby rising up is suppressed. Therefore, the inkjet printer 10 can form high-quality images on recording media 90 with ink which is ejected toward the recording medium 90 by the recording head 16 disposed at the position facing the supporting surface 31a of the print platen 31.

As described above, in the inkjet printer 10, since a part of the supporting surface 31a of the print platen 31 which does not support a recording medium 90 (hereinafter, referred to as a “medium non-support part”) can be covered by the sheets 34, whereby the through-holes 31b of the medium non-support part can be shielded, it is possible to suppress gas from being forced to flow through the through-holes 31b of the medium non-support part by the fan 33. Therefore, the inkjet printer 10 can suppress cooling of the print platen 31 due to the flow of gas through the through-holes 31b of the medium non-support part produced by the fan 33, and thus can improve the efficiency of heating of the print platen 31 by the print heater 32 as compared to that in the related art.

Also, in the inkjet printer 10, in a case where the print platen 31 is cooled if the fan 33 causes gas to flow through the through-holes 31b of the medium non-support part, it is needed to rise the temperature of the print heater 32 in order to heat the print platen 31 to an appropriate temperature. However, in the inkjet printer 10, since it is possible to suppress cooling of the print platen 31 due to the flow of gas through the through-holes 31b of the medium non-support part produced by the fan 33 as described above, it is unnecessary to rise the temperature of the print heater 32 unlike the above described case. In other words, the inkjet printer 10 can suppress unnecessary energy consumption.

Also, in the inkjet printer 10, since it is possible to use the sheet 34 to suppress the flow of gas through the through-holes 31b of the medium non-support part from being produced by the fan 33, as compared to a configuration in which gas is forced to flow through the through-holes 31b of the medium non-support part by the fan 33, it is possible to improve suction force which a flow of gas produced by the fan 33 causes to be applied on a recording medium 90 through the plurality of through-holes 31b of the print platen 31, and thus it is possible to improve the qualities of images formed on recording medium 90 with ink.

In the inkjet printer 10, since the print heater 32 is disposed in the space 30a where gas entering the through-holes 31b from the side of the supporting surface 31a of the print platen 31 and getting out of the through-holes 31b passes, gas entering the through-holes 31b from the side of the supporting surface 31a of the print platen 31 and getting out of the through-holes 31b passes the vicinity of the print heater 32, and thus the print heater 32 can be easily cooled by the gas. Therefore, the inkjet printer 10 further improves the efficiency of heating of the print platen 31 by the print heater 32, as compared to a configuration in which the print heater 32 is not disposed in the space 30a.

Also, the inkjet printer 10 may be configured such that the print heater 32 is not disposed in the space 30a.

In the inkjet printer 10, in a case where the sheets 34 move with respect to the print platen 31, the sheets 34 are wound. Therefore, as compared to a configuration in which the sheets 34 move with respect to the print platen 31 without being wound, it is possible to reduce a space for accommodating the sheets 34, and thus it is possible to reduce the size of the whole of the inkjet printer 10.

Also, the inkjet printer 10 may be configured such that the sheets 34 move with respect to the print platen 31 without being wound.

In the inkjet printer 10, as long as the positions of the guide members 37 relative to the print platen 31 change, the sheets 34 can be automatically wound around the rollers 35 by the biasing forces of the spiral springs 36. Therefore, as compared to a configuration in which a user manually winds the sheets 34 around the rollers 35, it is possible to suppress the burden of a user.

Also, the inkjet printer 10 may be configured such that a user manually winds the sheets 34 around the rollers 35.

In the inkjet printer 10, the guide members 37 have both of a function of fixing the sheets 34 with respect to the print platen 31 and a function of guiding conveyance of a recording medium 90. Therefore, as long as the guide members 37 are fixed with respect to the print platen 31 according to the width of a recording medium 90 in order to make the guide members 37 guide conveyance of the recording medium 90, it is possible to improve the efficiency of heating of the print platen 31 by the print heater 32 using the sheets 34.

Also, the inkjet printer 10 may be configured such that the function of fixing the sheets 34 with respect to the print platen 31 and the function of guiding conveyance of a recording medium 90 are implemented by separate members, respectively.

Although the inkjet printer 10 is configured in the illustrative embodiment such that a recording medium 90 is moved with respect to the print platen 31, it may be configured like a so-called flat bed type inkjet printer such that a recording medium 90 is not moved with respect to the print platen 31 and the recording head 16 is moved even in the sub scan direction shown by the arrow 10b.

### DESCRIPTION OF REFERENCE SIGNS

10 inkjet printer
16 recording head
30a space (space where gas passes)
31 print platen (platen)
31a supporting surface
31b through-hole
32 print heater (heater)
33 fan
34 sheet
35 roller (winding member)
36 spiral spring (biasing member)
37 guide member (fixed member)
90 recording medium

1. An inkjet printer, comprising:
a recording head, ejecting an ink;
a platen, supporting a recording medium onto which the recording head ejects the ink;
a heater, heating the platen;
a fan, producing a flow of gas; and
a sheet, being able to cover at least a part of the platen,
wherein the platen has a supporting surface for supporting the recording medium, and a plurality of through-holes formed in the supporting surface,
the fan produces the flow of gas by making gas existing on a side of the supporting surface with respect to the through-holes move through the through-holes, and
the sheet is capable of covering at least a part of the supporting surface to shield at least a part of the plurality of through-holes, and is capable of changing an area to cover the supporting surface.

2. The inkjet printer according to claim 1, wherein
the heater is disposed at a position on an opposite side of the side of the supporting surface with respect to the through-holes, and
the heater is disposed in a space where gas getting out of the through-holes passes.

3. The inkjet printer according to claim 1, further comprising:
a winding member, being able to wind the sheet; and
a fixed member, being attached to the sheet which is attached to the winding member, and the fixed member is fixable at a plurality of positions with respect to the platen.

4. The inkjet printer according to claim 3, further comprising:
a biasing member, biasing the winding member in a winding direction of the sheet.

5. The inkjet printer according to claim 3, wherein
the fixed member is a guide member that guides conveyance of the recording medium.

6. The inkjet printer according to claim 4, wherein
the fixed member is a guide member that guides conveyance of the recording medium.

7. The inkjet printer according to claim 2, further comprising:
a winding member, being able to wind the sheet; and
a fixed member, being attached to the sheet which is attached to the winding member, and the fixed member is fixable at a plurality of positions with respect to the platen.

8. The inkjet printer according to claim 7, further comprising:
a biasing member, biasing the winding member in a winding direction of the sheet.

9. The inkjet printer according to claim 7, wherein
the fixed member is a guide member that guides conveyance of the recording medium.

10. The inkjet printer according to claim 8, wherein
the fixed member is a guide member that guides conveyance of the recording medium.
